(19) United States
(12) Patent Application Publication
(10) Pub. No.: US 2009/0090275 A1
(43) Pub. Date: Apr. 9, 2009

(54) PIGMENT HAVING ANGLE DEPENDENCE OF THE INTERFERENCE COLORS AND THE PRODUCTION PROCESSES THEREOF

(75) Inventors: Jiansheng Fu, Shantou (CN); Yiting Peng, Shantou (CN); Xiaohui Tian, Shantou (CN)

Correspondence Address: SEED INTELLECTUAL PROPERTY LAW GROUP PLLC, 701 FIFTH AVE, SUITE 5400, SEATTLE, WA, 98104, US

(73) Assignee: SHANTOU LONGHUA PEARL LUSTRE CO., LTD., Shantou (CN)

(21) Appl. No.: 11/573,447

(22) PCT Filed: Jun. 9, 2005
(86) PCT No.: PCT/CN2005/000828

§ 371 Date: Nov. 17, 2008

(30) Foreign Application Priority Data
Aug. 10, 2004 (CN) 200410051129.1

(51) Int. Cl. C09C 1/28; B05D 1/36

(52) U.S. Cl. 106/415; 427/214

(57) ABSTRACT

The invention discloses multilayer allochroic pigments having angle dependence of the interference colors and the production processes thereof, in which a synthetic flake of silicate is used as the substrate, and a metal oxide coating with refractive index of more than 1.8 and an oxide coating with refractive index of less than 1.8 are deposited alternately on a surface of the flake of silicate, the number of the coatings is at least three, and said oxide coating with refractive index of less than 1.8 always lies between two metal oxide coatings with refractive index of more than 1.8. The processes involve a wet chemical hydrolysis step to alternately deposit said oxide coating with high refractive index and said oxide coating with high refractive index on the surface of the flake of silicate. The present pigments, which exhibit different strong interference colors as observed at different view angles, could be produced at a low cost and by a simple process.

### TECHNICAL FIELD

The present invention relates to allochroic pigments, more especially to pigments which exhibit different interference colors as observed at different view angles. The present invention also relates to methods for producing the allochroic pigments.

### BACKGROUND ART

Multilayer allochroic pigments will exhibit a color varying among two or more strong interference colors as observed at different view angles. Presently, most of this kind of pigment having angle dependence of the interference colors has a multilayer structure formed by coating metal oxide and non-metal oxide on a surface of substrate using vapor method, plasma sputtering method or wet chemical method. Although the production methods of pigments vary with the substrates, there are problems such as complex process, expensive cost, small variable color range and the like.

Multilayer pigments having opaque metal foils or metal oxides as substrates are produced by forming substrates on nets with a certain mesh or a soluble membrane, then coating metal oxide on one or both surface(s) of the metal foil using the vacuum sputtering method, and then peeling off, wherein said metal oxide coatings consist of alternate coatings with materials having low refractive index and high refractive index, and the color changes and color varying ranges of the multilayer pigments are varied by controlling the optical thickness of the coatings. This process requires an apparatus with high precision, chemicals with high purity, strict process control, and its yield is low. Therefore, its production cost is high, thereby restricting its mass application. Furthermore, the color and varying range thereof is not easily controlled.

Multilayer pigments having aluminum powders or synthetic ferric oxide flakes (said ferric oxide flakes are prepared by a high-temperature and high-pressure method) as substrates are produced by forming alternately coatings of metal oxide with low refractive index and with high refractive index on surfaces of the substrates using the vapor deposit method, carrying the organic metal compound with an inert gas into a boiling bed, then absorbing the organic metal compound onto the substrate and decomposing into a metal oxide at a certain temperature, and depositing on the substrate to form a coating with desired thickness on the surface of the substrate. The problems of this process lie in that it is difficult to add the substrate in a controlled metric manner and to disperse the substrate effectively in the boiling bed. Furthermore, the use of organic metal compounds will cause environmental problems. The pigment production process is complex, with high demand on the apparatus and the control precision chemicals, and the production cost of the substrate is high, and the like. Therefore, this product is high in cost, thereby restricting its wide application.

Allochroic pigments having synthetic silicon dioxides as substrates (the substrates are prepared by coating a certain concentration of water glass onto a special device, then drying and peeling off), are produced by hydrolyzing a soluble inorganic metal compound and a soluble non-metal compound to form a metal oxide and a non-metal oxide hydrate, by using wet chemical process, which are deposited onto the substrate, and a metal oxide coating with low refractive index and a metal oxide coating with high refractive index can be deposited alternately on the substrate. Because this process employs wet chemical process, it is easy to operate and control the optical thickness of desired coatings. Therefore, this process is simple and can be applied easily in mass production. It can also form only one metal oxide coating with high refractive index on the surface of the silicon dioxide substrate to achieve the effect of the angle dependence of the interference colors. However, the thickness of this kind of substrate is required to be less than 1 μm, usually in a range of 200-500 nm, which causes a great problem in the preparation of the substrate; thus the cost of the substrate is high, and its yield is low. The problems such as high cost and narrow application range also exist in these kinds of pigments.

U.S. Pat. No. 6,692,561 discloses pigments with strong interference colors in which mica is used as substrate. Said pigments are prepared by coating a first layer of metal oxide coating with low refractive index and a second layer of metal oxide coating with high refractive index on the mica substrate. Since the optimal value of the oxide coating thickness is not given, it is considered that the substantial problem has not been solved in this patent. Furthermore, as can be analyzed from its test data, the test angle in the patent is fixed. It can be seen that the color variation range is narrow. These kinds of pigments belong to ordinary allochroic pigments, and the angle dependence of the interference colors is not achieved.

The thickness of oxide coatings on substrates is difficult to measure, so that it is usually calculated in terms of coating ratio, i.e., the weight percent of oxide coating relative to the total weight of the pigment.

### DISCLOSURE OF THE INVENTION

An objective of the invention is to provide allochroic pigments which exhibit different strong interference colors as observed at different view angles and which can be produced at low cost and by a simple process.

Another objective of the invention is to provide methods for producing said allochroic pigments.

To achieve the above-mentioned objectives, the pigments of the present invention has a synthetic flake of silicate as a substrate, and a metal oxide coating with refractive index of more than 1.8 and an oxide coating with refractive index of less than 1.8 are deposited alternately on a surface of the synthetic flake of silicate. The number of the coatings is at least three, and said oxide coating with refractive index of less than 1.8 always lies between two metal oxide coatings with refractive index of more than 1.8.

The above-mentioned synthetic flake of silicate is a synthetic flake of sodium calcium silicate having a thickness of 0.1-10 μm and a particle diameter of 5-1500 μm, preferably a synthetic flake of sodium calcium silicate having a thickness of 1-5 μm and a particle diameter of 30-150 μm.

The above-mentioned metal oxide coating with refractive index of more than 1.8 has a coating ratio of 1-50%, preferably 3-30%.

The above-mentioned metal oxide coating with refractive index of less than 1.8 has a coating ratio of 5-80%, preferably 10-60%.

The above-mentioned metal oxide with refractive index of more than 1.8 is TiO₂, SnO₂, Fe₂O₃, Fe₃O₄, CoO, CO₂O₃, ZrO₂, Cr₂O₃ or a mixture or complex thereof.

The above-mentioned oxide with refractive index of less than 1.8 is SiO₂, Al₂O₃, Al(OH)₃, B₂O₃ or a mixture or complex thereof.

The present invention also provides a method for producing above-mentioned pigments, said method comprising the following steps:

Step (1), in which a synthetic flake of silicate is added into deionized water and stirred to form a suspension liquid with solid content of 1-20%; this suspension liquid is heated to 60-90° C. and adjusted to pH 2-9; and then a solution of a soluble inorganic metal salt is added to reach a coating ratio of metal oxide coating of 1-50%, while the pH value thereof is kept constant; and after finishing the addition of the solution, the mixture is stirred at a constant temperature for 10-30 minutes;

Step (2), in which the suspension liquid obtained in step (1) is adjusted to pH 6-14, then a solution of a soluble inorganic salt is added to reach a coating ratio of oxide coating of 5-80%, while the pH value of the suspension liquid is kept constant; and after finishing the addition of the solution, the mixture is stirred at a constant temperature for 10-30 minutes;

Step (3), in which the suspension liquid obtained in step (2) is adjusted to pH 2-9, then a solution of a soluble inorganic metal salt is added to reach a coating ratio of metal oxide coating of 1-50%, while the pH value thereof is kept constant, and after finishing the addition of the solution, the mixture is stirred at a constant temperature for 10-30 minutes;

Step (4), in which the suspension liquid obtained in step (3) is filtered, washed with deionized water, dried, calcined and sieved;

The above-mentioned steps (1), (2), and (3) can be repeated alternately,

wherein the metal oxide as a hydrolysate of said soluble inorganic metal salt has a refractive index of more than 1.8, and the oxide as a hydrolysate of said soluble inorganic salt has a refractive index of less than 1.8.

The above-mentioned soluble inorganic metal salt is selected from a group consisting of TiCl₄, TiOCl₂, SnCl₄, SnCl₂, FeCl₃, FeCl₂, CoCl₂, ZrOCl₂, CrCl₃ or the like.

The above-mentioned soluble inorganic salt is selected from a group consisting of water glass, silicate, AlCl₃, NaAlO₂, borax or the like.

The drying temperature in the above-mentioned step (4) is 100-150° C., and the calcining temperature is 250-1000° C.

The multilayer allochroic pigments having angle dependence of the interference colors of the invention have the following advantages□

Because synthetic flakes of silicate are used as the substrates for the pigments of the invention, this substrate material can be easily obtained in a low price, so that the present pigments are much lower in cost as compared with those having opaque metal foil or metal oxide, synthetic silicon dioxide, and silicone liquid crystal plate as substrates, thereby broadening its application fields.

The pigments of the present invention are produced by a method wherein metal oxide coatings with high refractive index are first formed on the surfaces of the synthetic flakes of silicate such that the active groups on the surfaces of the flakes of silicate are distributed homogeneously to achieve consistent optical properties, and then an oxide coating with low refractive index is coated directly to a desired thickness, and another metal oxide coating with high refractive index is coated thereafter, thereby an effect that different strong interference colors can be observed at different view angles is obtained.

The substrates used in the present pigments are synthetic flakes of silicate which have a single layer structure. When they are irradiated with light, the light refraction number of the present pigments will be much less than those of pigments having mica as substrates, while the reflection strength of the former will be much greater than that of the latter. Therefore, the vividness and brightness of the color of the present pigments is much better than that of pigments having mica as substrates in a macroscopical view.

In the method of the present invention, because a wet chemical hydrolysis step is employed, an oxide coating with high refractive index and an oxide coating with low refractive index can be coated alternately on a surface of the synthetic flake of silicate substrate once or several times, so this coating method is flexible. Using the method, many tones and different color variation ranges can be prepared. The colors in one color variation range can be changed for two, three or more times, until all the color range is covered. During the coating via hydrolysis, the coating ratio of the metal oxide coating can be controlled by the amount of the inorganic salt solution added, thus its optical thickness can be controlled to achieve the change of color phase of the pigments.

The method of the present invention is easy in operation and quality control, and the quality of products is stable. Furthermore, because a wet chemical hydrolysis process for coating is used, this method can be applied in mass production. Furthermore, a hydrolysate of the soluble inorganic metal compound is easy to handle and causes minimal environmental problems.

### EXAMPLES

### Example 1

The present example is illustrated by pigments having a structure of Fe₂O₃/SiO₂/Fe₂O₃/flake of silicate/Fe₂O₃/SiO₂/Fe₂O₃.

100 g of flakes of sodium calcium silicate powders having a thickness of 1-5 μm and a particle diameter of 30-150 μm were suspended in 1000 ml of deionized water, and the suspension liquid was stirred and heated to 75° C.

The pH value of the suspension liquid was adjusted to 3.5 using 18% hydrochloric acid solution, and then 200 ml of 10% ferric chloride solution was added metrically. The pH of the suspension liquid was kept constant by adding dropwise 15% sodium hydroxide solution during this process. After finishing the addition, the mixture was stirred at a constant temperature for another 15 minutes.

The pH of the suspension liquid was adjusted to 9.5 using 32% sodium hydroxide solution, and then the suspension liquid was stirred for 15 minutes.

3 L of sodium silicate solution (13 g/L in term of SiO₂) was added dropwise metrically. The pH of the suspension liquid was kept constant by adding dropwise 15% hydrochloric acid solution during this process. After finishing the addition, the mixture was stirred at a constant temperature for another 30 minutes.

The pH value of the suspension liquid was adjusted to 3.5 using 18% hydrochloric acid solution, and the suspension liquid was stirred at a constant temperature for 30 minutes. Then, 70 ml of 120 g/L ferric chloride solution was added dropwise. The pH of the suspension liquid was kept constant by adding dropwise 15% sodium hydroxide solution during this process. After finishing the addition, the mixture was stirred at a constant temperature for another 15 minutes.

The suspension liquid was filtered. The residue was washed with deionized water, dried at 120° C., calcined at 500° C., then passed through a 100 mesh sieve, thus a product was obtained.

The total oxide coating ratio of the resultant product was 35.9%, wherein the coating ratio of first layer of ferric oxide was 7.6%, the coating ratio of second layer of silicon dioxide was 25.7%, and the coating ratio of third layer of ferric oxide was 2.65%.

The resultant product was mixed with a transparent and colorless adhesion agent made of cellulose nitrate in an appropriate ratio, and then the mixture was drawn down onto a drawdown paper with black and white bases. As viewed from a vertical view angle to a horizontal view angle, the exhibited color value was a color value flowing from purple-red to yellow-green.

### Example 2

The present example is illustrated by pigments having a structure of Fe₂O₃/SiO₂/Fe₂O₃/flake of silicate/Fe₂O₃/SiO₂/Fe₂O₃.

100 g of flakes of sodium calcium silicate powders having a thickness of 1-5 μm and a particle diameter of 10-60 μm were suspended in 1000 ml of deionized water, and the suspension liquid was stirred and heated to 75° C.

The pH value of the suspension liquid was adjusted to 3.5 using 18% hydrochloric acid solution, and then 300 ml of 10% ferric chloride solution was added metrically. The pH of the suspension liquid was kept constant by adding dropwise 15% sodium hydroxide solution during this process. After finishing the addition, the mixture was stirred at a constant temperature for another 15 minutes.

The pH of the suspension liquid was adjusted to 9.5 using 32% sodium hydroxide solution, and then the suspension liquid was stirred for 15 minutes.

4 L of sodium silicate solution (13 g/L in term of SiO₂) was added dropwise metrically. The pH of the suspension liquid was kept constant by adding dropwise 15% hydrochloric acid solution during this process. After finishing the addition, the mixture was stirred at a constant temperature for another 30 minutes.

The pH value of the suspension liquid was adjusted to 3.5 using 18% hydrochloric acid solution, and the suspension liquid was stirred at a constant temperature for 30 minutes. Then, 94 ml of 120 g/L ferric chloride solution was added dropwise. The pH of the suspension liquid was kept constant by adding dropwise 15% sodium hydroxide solution during this process. After finishing the addition, the mixture was stirred at a constant temperature for another 15 minutes.

The suspension liquid was filtered. The residue was washed with deionized water, dried at 120° C., calcined at 500° C., then passed through a 100 mesh sieve, thus a product was obtained.

The total oxide coating ratio of the resultant product was 41.25%, wherein the coating ratio of first layer of ferric oxide was 8.68%, the coating ratio of second layer of silicon dioxide was 30.55%, and the coating ratio of third layer of ferric oxide was 2.04%.

The resultant product was mixed with a transparent and colorless adhesion agent made of cellulose nitrate in an appropriate ratio, and then the mixture was drawn down onto a drawdown paper with black and white bases. As viewed from a vertical view angle to a horizontal view angle, the exhibited color value was a color value flowing from purple-red to yellow-green.

The above-mentioned coating of metal oxide with high refractive index and metal oxide with low refractive index can be carried out alternately for several times to form different structures, such as Fe₂O₃/SiO₂/Fe₂O₃/SiO₂/Fe₂O₃/SiO₂/Fe₂O₃/flake of silicate/Fe₂O₃/SiO₂/Fe₂O₃/SiO₂/Fe₂O₃/SiO₂/Fe₂O₃, or TiO₂/Fe₂O₃/SiO₂/Fe₂O₃/TiO₂/flake of silicate/TiO₂/Fe₂O₃/SiO₂/Fe₂O₃/TiO₂. Thus, pigments with multiple tones and different color variation ranges were prepared.

The above-mentioned examples are provided only for illustrating the present multilayer allochroic pigments having angle dependence of the interference colors and their production process, without restricting the scope of the present invention. It is understood that any equivalent embodiment or alteration of the technical solution of the present invention is included within the scope of the present invention.

1. Multilayer allochroic pigments having angle dependence of interference colors comprising:
a synthetic flake of silicate as a substrate;
a metal oxide coating with refractive index of more than 1.8; and
an oxide coating with refractive index of less than 1.8, wherein the metal oxide coating and the oxide coating are deposited alternately on a surface of the synthetic flake of silicate, a total number of the coatings is at least three, said oxide coating with refractive index of less than 1.8 always lies between two metal oxide coatings with refractive index of more than 1.8, and said synthetic flake of silicate is a synthetic flake of sodium calcium silicate having a thickness of 0.1-10 μm and a particle diameter of 5-1500 μm.

2. The pigments according to claim 1, wherein said synthetic flake of silicate is a synthetic flake of sodium calcium silicate having a thickness of 1-5 μm and a particle diameter of 30-150 μm.

3. The pigments according to claim 1, wherein said metal oxide coating with refractive index of more than 1.8 has a coating ratio of 1-50%.

4. The pigments according to claim 1, wherein said oxide coating with refractive index of less than 1.8 has a coating ratio of 5-80%.

5. The pigments according to claim 3, wherein said metal oxide coating with refractive index of more than 1.8 has a coating ratio of 3-30%.

6. The pigments according to claim 4, wherein said oxide coating with refractive index of less than 1.8 has a coating ratio of 10-60%.

7. The pigments according to claim 1, wherein said metal oxide with refractive index of more than 1.8 is TiO₂, SnO₂, Fe₂O₃, Fe₃O₄, CoO, CO₂O₃, ZrO₂, Cr₂O₃, a mixture or a complex thereof.

8. The pigments according to claim 1, wherein said oxide with refractive index of less than 1.8 is SiO₂, Al₂O₃, Al(OH)₃, B₂O₃, a mixture or a complex thereof.

9. A method for producing the pigments according to claim 1, comprising the following steps:
step (1), adding a synthetic flake of silicate having a thickness of 0.1-10 μm and a particle diameter of 5-1500 μm into a certain amount of deionized water, which is stirred to form a suspension liquid with solid content of 1-20%; heating the suspension liquid to 60-90° C.; adjusting the suspension liquid to pH 2-9; adding a first solution of a soluble inorganic metal salt to reach a coating ratio of a first metal oxide coating of 1-50%, while keeping the pH value thereof constant at pH 2-9;
step (2), adjusting the pH of the suspension liquid obtained in step (1) to pH 6-14, adding a solution of a soluble inorganic salt to reach a coating ratio of oxide coating of 5-80%, while keeping the pH value of the suspension liquid constant at pH 6-14;
step (3), adjusting the pH of the suspension liquid obtained in step (2) to pH 2-9, adding a second solution of a soluble inorganic metal salt to reach a coating ratio of a second metal oxide coating of 1-50%, while keeping the pH value thereof constant at pH 2-9;
step (4), filtering the suspension liquid obtained in step (3) to provide the pigments;
wherein each of the first metal oxide and second metal oxide is a hydrolysate of said respective soluble inorganic metal salt and has a refractive index of more than 1.8, and the oxide is a hydrolysate of said soluble inorganic salt and has a refractive index of less than 1.8.

10. The method according to claim 9, wherein that said synthetic flake of silicate is a synthetic flake of sodium calcium silicate having a thickness of 1-5 μm and particle diameter of 30-150 μm.

11. The method according to claim 9, wherein the above-mentioned steps (1), (2), and (3) can be repeated alternately.

12. The method according to claim 9, wherein said soluble inorganic metal salt is selected from a group consisting of TiCl₄, TiOCl₂, SnCl₄, SnCl₂, FeCl₃, FeCl₂, CoCl₂, ZrOCl₂ and CrCl₃.

13. The method according to claim 9, wherein said soluble inorganic salt is selected from a group consisting of water glass, silicate, AlCl₃, NaAlO₂ and borax.

14. The method according to claim 9, wherein the pigments are dried at a temperature of about 100-150° C., and calcined at a temperature of about 250-1000° C.

15. The method according to claim 9 wherein the solution of the first soluble metal salt and the solution of the second soluble metal salt can be the same or different.

16. The multilayer allochroic pigments of claim 1 wherein the metal oxide coating is Fe₂O₃ and the oxide coating is SiO₂.

17. The multilayer allochroic pigments of claim 16 wherein the total number of the coatings is 3.

18. The multilayer allochroic pigments of claim 16 further comprising a TiO₂ coating.

19. The multilayer allochroic pigments of claim 16 wherein the total number of the coatings is 5.

20. The multilayer allochroic pigments of claim 16 wherein the total number of the coatings is 7.
